(19) United States
(12) Patent Application Publication
(10) Pub. No.: US 2012/0061226 A1
(43) Pub. Date: Mar. 15, 2012

(54) SWITCH DEVICE AND ELECTRONIC APPARATUS

(75) Inventors: Takashi EDO, Koto-ku (JP); Akimi YAMASAKI, Sakura-shi (JP); Tomosada INADA, Sakura-shi (JP)

(73) Assignee: FUJIKURA LTD., Tokyo (JP)

(21) Appl. No.: 13/299,519

(22) Filed: Nov. 18, 2011

Related U.S. Application Data
(63) Continuation of application No. PCT/JP2010/058656, filed on May 21, 2010.

(30) Foreign Application Priority Data
May 22, 2009 (JP) 2009-123964

(51) Int. Cl. H01H 1/06

(52) U.S. Cl. 200/513; 200/512

(57) ABSTRACT

A switch device includes: a circuit board provided with a fixed contact; a deformable contact arranged above the circuit board, and configured to deform and come into contact with the fixed contact in response to pressure from above; a switch holding sheet covering a surface of the circuit board provided with the deformable contact, and configured to retain the deformable contact on the circuit board; a light-guide sheet placed over the switch holding sheet, and allowing light to pass through its inside; a light-emitting diode configured to cause the light to fall incident and enter the inside of the light-guide sheet; and a protrusion forming a gap between the switch holding sheet and the light-guide sheet in a position corresponding to the deformable contact.

### CROSS-REFERENCE

This application is a Continuation of PCT Application No. PCT/JP2010/058656, filed on May 21, 2010, and claims the priority of Japanese Patent Application No. 2009-123964, filed on May 22, 2009, the content of both of which is incorporated herein by reference.

### BACKGROUND

The present invention relates to a switch device configured to illuminate a key surface by using a light-guide sheet, and an electronic apparatus using the same.

### DESCRIPTION OF THE RELATED ART

FIG. 1 shows a conventional switch device 100 disclosed in Japanese Patent Application Publication No. 2007-324100. This switch device 100 includes: a circuit board 102 provided with multiple fixed contacts 101; multiple deformable contacts 103 arranged above the circuit board 102; a switch holding sheet 104 covering a surface of the circuit board 101 provided with the multiple deformable contacts 103; a light-guide sheet 105 placed over the switch holding sheet 104; a light-emitting diode 106 arranged outside of a side surface of this light-guide sheet 105, and serving as a light source for emitting light from the side surface to the inside; and a key sheet 107 arranged above the light-guide sheet 105.

The deformable contacts 103 are formed in a dome shape, and are configured to elastically deform and come into contact with the respective fixed contacts 101 in response to pressure from above. Each deformable contact 103 and its corresponding fixed contact 101 collectively constitute a press switch unit 110.

The switch holding sheet 104 has a shape that makes the switch holding sheet 104 retain the dome shapes of the deformable contacts 103 from outside, and retains the deformable contacts 103 in their predetermined positions on the circuit board 102.

The light-guide sheet 105 deforms due to its own weight in a way that makes the light-guide sheet 105 agree with the undulation attributable to the deformable contacts 103, and is arranged in a undulating state.

The key sheet 107 has key top portions 107a and pressing portions 107b, respectively, in positions corresponding to the deformable contacts 103. Operational information is indicated on each key top portion 107a. The key sheet 107 is made of a light transmissive material.

The light from the light-emitting diode 106 enters the light-guide sheet 105. The light travels inside the light-guide sheet 105, and part of the light is scattered. Part of the scattered light leaks out, and exits the key sheet 107. In this way, the key sheet 107 is illuminated so that a user can manipulate the key sheet 107 even in a dark place while visually checking the operational information on the key sheet 107.

### SUMMARY OF INVENTION

The light-guide sheet 105 has a function to transmit a pressing force from a key surface to the switch holding sheet 104, a function to cause the light to pass through its inside, and the like. As the light-guide sheet 105, a silicone-based sheet or a urethane-based sheet is used. However, since these sheet materials have adhesive properties, and the light-guide sheet 105 easily adheres (sticks) to the switch holding sheet 104. When the light-guide sheet 105 sticks to the switch holding sheet 104, the light is scattered in the portion where the light-guide sheet 105 adheres thereto. This causes the light to leak out of a position other than a desired position (i.e., a position in which the light is intended to scatter). Therefore, this leak causes a problem of a loss of illumination uniformity on the key surface.

The present invention has been made for solving the aforementioned problem, and an object thereof is to provide a switch device configured to illuminate a key surface by using a light-guide sheet, which is capable of maintaining illumination uniformity as much as possible.

A first aspect of the present invention is a switch device including: a circuit board provided with a fixed contact; a deformable contact arranged above the circuit board, and configured to deform and come into contact with the fixed contact in response to pressure from above; a switch holding sheet covering a surface of the circuit board provided with the deformable contact, and configured to retain the deformable contact on the circuit board; a light-guide sheet placed over the switch holding sheet, and allowing light to pass through its inside; a light source configured to cause the light to fall incident and enter the inside of the light-guide sheet; and a protrusion provided between the switch holding sheet and the light-guide sheet or between the deformable contact and the light-guide sheet in a position corresponding to the deformable contact, and forming a gap between the switch holding sheet and the light-guide sheet.

The deformable contact may be formed in a dome shape, and the protrusion may be provided in a position corresponding to a top portion of the dome-shaped deformable contact.

The height of the protrusion may be in a range of 0.05 mm to 0.2 mm, and the diameter of the protrusion may be in a range of 0.7 mm to 2.5 mm.

The protrusion may have a columnar shape or a semispherical shape.

A second aspect of the present invention is an electronic apparatus including the foregoing switch device.

### BRIEF DESCRIPTION OF THE DRAWINGS

FIG. 1 is a cross-sectional view of a conventional switch device.

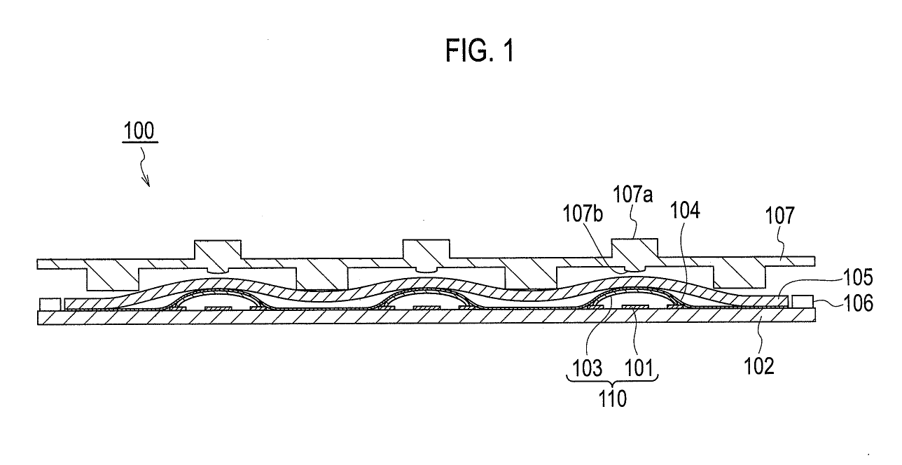

FIG. 2 is an exploded perspective view of a switch device of a first embodiment of the present invention.

FIG. 3 is a cross-sectional view of the switch device of the first embodiment of the present invention.

FIG. 4 is an enlarged view of a main part of the switch device shown in FIG. 3.

FIG. 5 is a cross-sectional view of a main part of a switch device of a second embodiment of the present invention.

### DETAILED DESCRIPTION OF THE EXEMPLARY EMBODIMENTS OF THE INVENTION

Embodiments of the present invention will be described below based on the drawings.

### First Embodiment

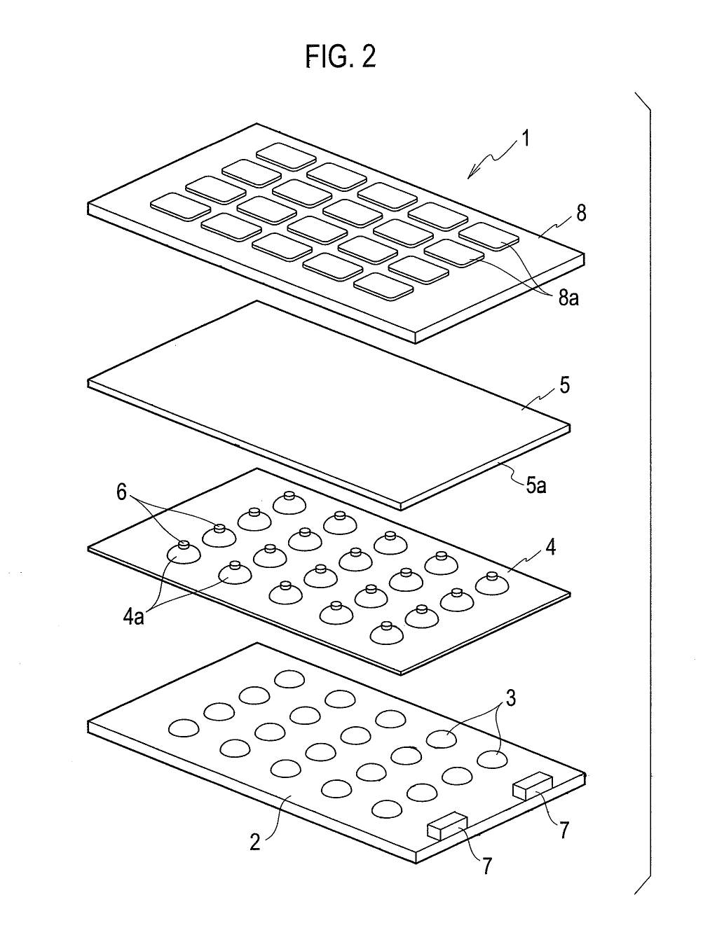

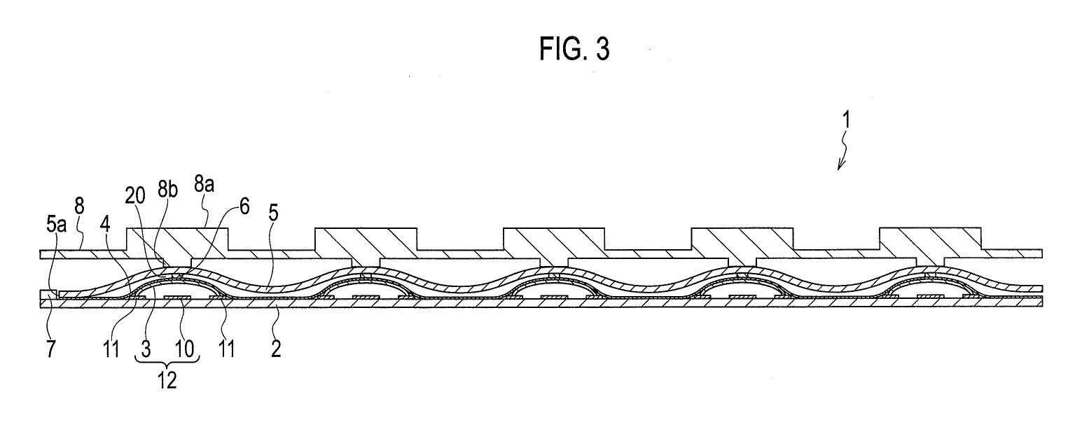

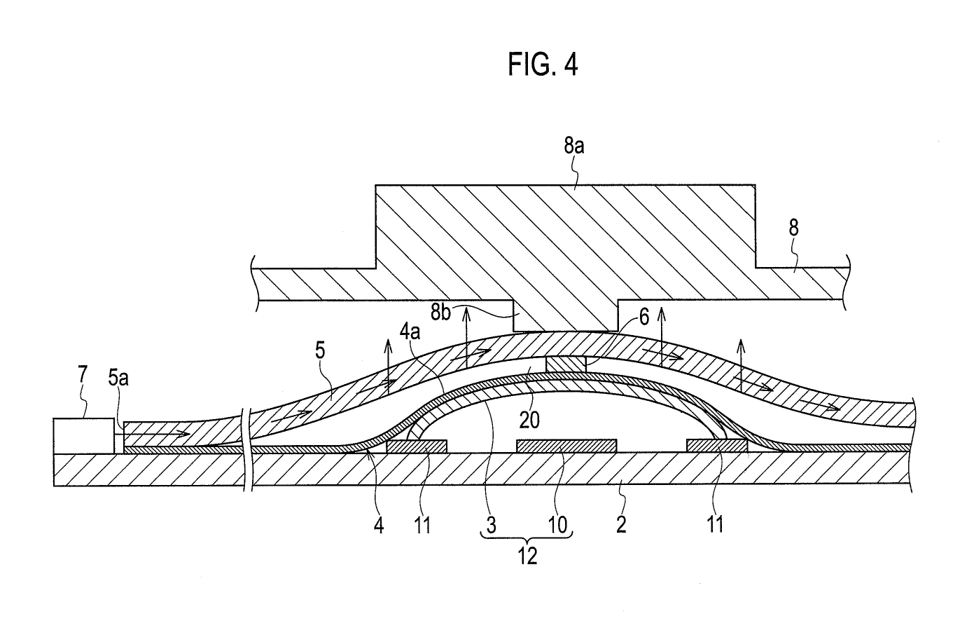

FIG. 2 to FIG. 4 show a first embodiment of the present invention. FIG. 2 is an exploded perspective view of a switch device 1. FIG. 3 is a cross-sectional view of the switch device 1 shown in FIG. 2; and FIG. 4 is an enlarged view of a main part shown in FIG. 3.

As shown in FIG. 2 and FIG. 3, the switch device 1 is mounted on an information input unit of an electronic apparatus such as a cellular telephone. The switch device 1 includes: a circuit board 2; multiple deformable contacts 3 arranged above this circuit board 2; a switch holding sheet 4 covering a surface of the circuit board 2 provided with these multiple deformable contacts 3; a light-guide sheet 5 placed over the switch holding sheet 4; multiple protrusions 6 interposed between the switch holding sheet 4 and the light-guide sheet 5; light-emitting diodes 7 arranged outside of a side surface of the light-guide sheet 5, and serving as a light source for emitting light from the side surface of the light-guide sheet 5 to the inside; and an key sheet 8 arranged above the light-guide sheet 5.

The circuit board 2 is either a printed circuit board (PCB) or a flexible printed circuit (FPC), which is made of polyimide, polyethylene terephthalate (PET) or the like. The circuit board includes a circuit pattern, which is formed by printing a conductive material on a surface thereof, for example. This circuit pattern includes multiple fixed contacts 10 and multiple annular contacts 11 respectively arranged around these fixed points 10.

Each of the deformable contacts 3 is formed by processing a thin plate, which is made of metal such as stainless steel or copper having flexibility and conductivity, into a dome shape. A peripheral lower end of each of the dome-shaped deformable contacts 3 is arranged on the annular contact 11, and each fixed contact 10 is located inside its corresponding deformable contact 3. The deformable contact 3 and the fixed contact 10 collectively constitute a press switch unit 12. Moreover, the deformable contact 3 is not connected to the fixed contact 10 in a state where a pressing force is not applied to the deformable contact 3. When the pressing force acts on the deformable contact 3, a top portion thereof elastically deforms in a way that makes the top portion sink toward the fixed contact 10 and touches the fixed contact 10. As a consequence, the deformable contact 3 is electrically connected to the fixed contact 10.

The switch holding sheet 4 is an insulating white sheet having a thickness of 0.07 mm, which is made of polyester or olefin, for example. The switch holding sheet 4 includes dome-shaped projecting portions 4a located in positions corresponding to the respective deformable contacts 3, and covers the deformable contacts 3 substantially without spaces therebetween. Thereby, the switch holding sheet 4 retains the deformable contacts 3 in their respective predetermined positions on the circuit board 2. The sheet holding sheet 4 is bonded to the circuit board 2 and the multiple deformable contacts 3 by using an adhesive.

The light-guide sheet 5 is made of a material having translucency such as transparent silicone, urethane, polyester, polycarbonate or methacrylic resin. The light-guide sheet 5 has a size substantially same as that of the circuit board 2, and has a thickness in a range of about 0.1 mm to 0.3 mm, for example. The light-guide sheet 5 deforms due to its own weight substantially along the undulation attributable to the deformable contacts 3 and the protrusions 6, and is arranged in an undulating state. The inside of the light-guide sheet 5 serves as an optical path. The undulating shape of the light-guide sheet 5 allows a predetermined proportion of the light to leak out of predetermined positions due to its scattering and thereby to maintain uniformity of illumination as the entire light-guide sheet 5.

The protrusions 6 are provided between the switch holding sheet 4 and the light-guide sheet 5, and in positions corresponding to the top portions of the deformable contacts 3, respectively. The protrusions 6 form gaps 20 between the switch holding sheet 4 and the light-guide sheet 5 in the positions corresponding to the deformable contacts 3, respectively. Each of the protrusions 6 has a columnar shape. The height of each protrusion 6 is in a range of 0.05 mm to 0.2 mm, and the diameter thereof is in a range of 0.7 mm to 2.5 mm. The protrusions 6 are made of ultraviolet curable resin. Specifically, the protrusions 6 are formed by: placing columnar ultraviolet curable resin in the positions corresponding to the top portions of the deformable contacts 3 (the top portions of the dome-shaped portions 4a in the case of the switch holding sheet 4) on the surface of the switch holding sheet 4 or the light-guide sheet 5; and curing this columnar ultraviolet curable resin by casting ultraviolet rays thereon.

The light-emitting diodes 7 are mounted on the circuit board 2. The light-emitting diodes 7 are lateral light-emitting diodes configured to emit the light in a direction parallel to the surface of the circuit board 2. The light-emitting diodes 7 cause the light to fall incident on the one side surface 5a of the light-guide sheet 5, and to enter the inside thereof. In FIG. 4, an example of a direction of the light traveling inside the light-guide sheet 5 from the light-emitting diode 7 is indicated with an arrow.

The key sheet 8 includes key top portions 8a and pressing portions 8b in positions corresponding to the deformable contacts 3, respectively. Operational information is indicated on each of the key top portions 8a. Front surfaces of the key top portions 8a constitute a key surface. The key sheet 8 is made of a translucent material.

In the switch device 1 having the above-described configuration, the light from the light-emitting diodes 7 is caused to fall incident and enter the side of the light-guide sheet 5. The incident light travels inside the light-guide sheet 5 and is partially scattered. Part of this scattered light leaks out, and exits the key sheet 7. Thereby, the key sheet 7 is illuminated so that a user can manipulate the key sheet 7 even in a dark place while visually checking the operational information on the key sheet 7.

As described above, the protrusions 6 are provided between the switch holding sheet 4 and the light-guide sheet 5 in the positions corresponding to the deformable contacts 3, respectively. Therefore, the gaps 20 are formed around the protrusions 6. For this reason, it is highly unlikely that the light-guide sheet 5 comes into firmly adhering to the switch holding sheet 4 even when the light-guide sheet 5 has an adhesive property. Accordingly, it is possible to maintain illumination uniformity as much as possible in the structure configured to illuminate the key surface by using the light-guide sheet 5.

Moreover, the gaps 20 corresponding to the heights of the protrusions 6 is securely formed around the neighborhoods of the protrusions 6 between the switch holding sheet 4 and the light-guide sheet 5. This structure has an advantage for reducing the likelihood of the firm adherence between the switch holding sheet 4 and the light-guide sheet 5.

The deformable contacts 3 have the dome shape, and the protrusions 6 are provided in the positions corresponding to the top portions of the dome-shaped deformable contacts 3, respectively. When the user presses the position corresponding to the top portion of one of the dome-shaped deformable contacts 3, the pressing force is transmitted to the corresponding deformable contact 3 via the protrusion 6. Further, a reaction force against the pressing force generated when the deformable contact 3 touches the fixed contact 10 is transmitted to the user via the protrusion 6. For this reason, the user can sense clear feeling when the deformable contact 3 touches the fixed contact 10.

Although the protrusions 6 are provided in the positions corresponding to the top portions of the deformable contacts 3, the protrusions 6 may be located in any arbitrary positions as long as the arbitrary positions enable the gaps 20 to be formed between the switch holding sheet 4 and the light-guide sheet 5. Although each deformable contact 3 is provided with only one protrusion 6, each deformable contact 3 may be provided with multiple protrusions instead.

Further, because the protrusions 6 have the height in the range from 0.05 mm to 0.2 mm and the diameter in the range from 0.7 mm to 2.5 mm, the protrusions 6 make it possible to reliably prevent the firm adherence between the switch holding sheet 4 and the light-guide sheet 5, and to obtain satisfactory switch durability and switch feeling. The reason for this will be elaborated in the following section of examples.

### Second Embodiment

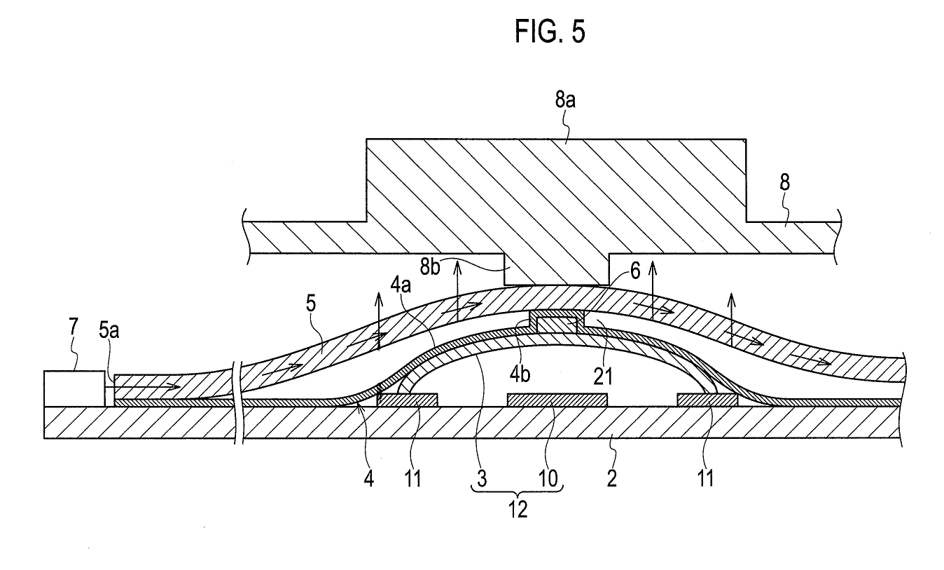

FIG. 5 is a cross-sectional view of a main part of a switch device showing a second embodiment of the present invention. As shown in FIG. 5, the switch device of the second embodiment is different from the switch device of the first embodiment in that the multiple protrusions 6 are arranged between the respective deformable contacts 3 and the switch holding sheet 4. To be more precise, recess portions 4b recessed upward are formed in top portions of the dome-shaped projecting portions 4a (the positions corresponding to the top portions of the deformable contacts 3) on the switch holding sheet 4. The protrusions 6 are located inside the recess portions 4b. Even while an upper surface of the switch holding sheet 4 located on the upper surfaces of the protrusions 6 contacts the light-guide sheet 5, gaps 21 are formed between the switch holding sheet 4 and the light-guide sheet 5 around the protrusions 6 by the recess portions 4b and the protrusions 6, respectively. Each protrusion 6 has a columnar shape. The height of each protrusion 6 is in the range of 0.05 mm to 0.2 mm, and the diameter thereof is in the range of 0.7 mm to 2.5 mm. Each protrusion is made of polyethylene terephthalate (PET resin). The protrusions 6 are formed by arranging columnar PET resin in the positions corresponding to the top portions of the deformable contacts 3 on the switch holding sheet 4, i.e., in the recess portions 4b in the switch holding sheet 4. Note that this columnar PET resin may be fixed to the recess portions 4b by using any of a bonding agent and an adhesive agent, or may be simply fitted into the recess portions 4b without using any of the above.

The rest of the configuration is similar to that in the above-described first embodiment. Accordingly, the same constituents are denoted by the same reference numerals, and description thereof will be omitted.

In this switch device of the second embodiment, the gaps 21 are formed in the positions corresponding to the deformable contacts 3 between the switch holding sheet 4 and the light-guide sheet 5, like in the switch device of the first embodiment. For this reason, it is highly unlikely that the light-guide sheet 5 comes into firmly adhering to the switch holding sheet 4 even when the light-guide sheet 5 has an adhesive property. Accordingly, it is possible to maintain illumination uniformity as much as possible in the structure configured to illuminate the key surface by using the light-guide sheet 5.

Because the protrusions 6 are arranged inside the recess portions 4b in the switch holding sheet 4, the protrusions 6 are securely fixed to the appropriate positions. Therefore, the protrusion 6 will not be displaced. Moreover, it is easy to carry out a manufacturing operation.

### Other Embodiments

In the first embodiment, the protrusions 6 are provided between the switch holding sheet 4 and the light-guide sheet 5. In the second embodiment, the protrusions 6 are provided between the switch holding sheet 4 and the deformable contacts 3. By providing the protrusions 6, the gaps 20, 21 are formed in the positions corresponding to the deformable contacts 3 between the switch holding sheet 4 and the light-guide sheet 5. Instead, however, these two types of protrusions 6 may be provided simultaneously in a way that one type of protrusions 6 are provided between the switch holding sheet 4 and the light-guide sheet 5 while the other type of protrusions 6 are provided between the switch holding sheet 4 and the deformable contacts 3.

The above-described protrusions 6 are not limited to the column-shape ones, but may also be formed in a semispherical shape.

In the first embodiment and the second embodiment, the light-emitting diodes 7 may be arranged so as to cause the light to fall incident on not only the one side surface 5a of the light-guide sheet 5, but also two or more side surfaces thereof. Moreover, the light source is not limited to the light-emitting diodes 7.

### EXAMPLES

As shown on Table 1 given below, the presence or absence of the contact between the switch holding sheet 4 and the light-guide sheet 5, the quality of the switch durability, and the quality of the switch feeling were examined for 10 types of examples (Examples 1 to 10) which were different from one another in at least one of the material, position, height and diameter of the protrusions 6, and a comparative example (a conventional example) provided with no protrusion 6. The protrusions 6 were columnar throughout the examples and the conventional example 6. Details will be described below.

TABLE 1

| | Example | Example | Example | Example | Example | Example | Example | Example | Example | Example | Comparative |
|---|---|---|---|---|---|---|---|---|---|---|---|
| | 1 | 2 | 3 | 4 | 5 | 6 | 7 | 8 | 9 | 10 | Example |
| Material of | UV | UV | UV | UV | PET Resin | PET Resin | PET Resin | PET Resin | PET | PET | Nothing |
| Protrusion | Curable | Curable | Curable | Curable | with | with | with | with | Resin | Resin | |
| | Resin | Resin | Resin | Resin | Adhesive | Adhesive | Adhesive | Adhesive | | | |
| | | | | | Agent | Agent | Agent | Agent | | | |
| Position of | Position | Position | Position | Position | Position | Position | Position | Position | Position | Position | — |
| Protrusion | A* | A* | A* | B** | A* | B** | B** | B** | B** | B** | |
| Height (mm) | 0.2 | 0.15 | 0.15 | 0.15 | 0.05 | 0.05 | 0.05 | 0.05 | 0.2 | 0.05 | — |
| Diameter (mm) | 2.5 | 2.0 | 0.7 | 1.0 | 1.0 | 0.7 | 2.5 | 0.7 | 1.0 | 1.0 | — |
| Contact | Absent | Absent | Absent | Absent | Absent | Absent | Absent | Absent | Absent | Absent | Present |
| between switch | | | | | | | | | | | |
| holding sheet | | | | | | | | | | | |
| and light-guide | | | | | | | | | | | |
| sheet | | | | | | | | | | | |
| Switch | Satisfied | Satisfied | Satisfied | Satisfied | Satisfied | Satisfied | Satisfied | Satisfied | Satisfied | Satisfied | Satisfied |
| Durability | | | | | | | | | | | |
| Switch Feeling | ∘ | ∘ | ∘ | ∘ | ∘ | ∘ | ∘ | ∘ | ∘ | ∘ | x |

*Position A: between switch holding sheet and light-guide sheet
**Position B: between deformable contacts and switch holding sheet

As for the material of the protrusions 6, ultraviolet curable resin was used in Example 1 to Example 4, PET resin with an adhesive agent was used in Example 5 to Example 8, and PET resin without the adhesive agent was used in Examples 9 and 10.

In Example 1, the protrusions 6 were provided between the switch holding sheet 4 and the light-guide sheet 5 (indicated as Position A in Table 1). The height of the protrusions 6 was set at 0.2 mm, and the diameter of the protrusions 6 was set at 2.5 mm. In Example 2, the height of the protrusions 6 was changed to 0.15 mm, and the diameter of the protrusions 6 was changed to 2.0 mm, unlike in Example 1. In Example 3, the diameter of the protrusions 6 was set at 0.7 mm, unlike in Example 2. In Example 4, the protrusions 6 were provided between the deformable contacts 3 and the switch holding sheet 4 (indicated as Position B in Table 1). The height of the protrusions 6 was set at 0.15 mm, and the diameter of the protrusions 6 was set at 1.0 mm.

In Example 5, the protrusions 6 were provided between the switch holding sheet 4 and the light-guide sheet 5 (indicated as Position A). The height of the protrusions 6 was set at 0.05 mm, and the diameter of the protrusions 6 was set at 1.0 mm. In Example 6, the protrusions 6 were provided between the deformable contacts 3 and the switch holding sheet 4 (indicated as Position B). The height of the protrusions 6 was set at 0.05 mm, and the diameter of the protrusions 6 was set at 0.7 mm. In Example 7, the diameter of the protrusions 6 was changed to 2.5 mm, unlike in Example 6. In Example 8, the diameter of the protrusions 6 was changed to 0.7 mm, unlike in Example 6.

In Example 9, the protrusions 6 were provided between the deformable contacts 3 and the switch holding sheet 4 (indicated as Position B). The height of the protrusions 6 was set at 0.2 mm, and the diameter of the protrusions 6 was set at 1.0 mm. In Example 10, the height of the protrusions 6 was changed to 0.05 mm, unlike in Example 9.

First, the presence or absence of the contact between the switch holding sheet 4 and the light-guide sheet 5 around the protrusions 6 was examined. As shown in Table 1, no contact between the switch holding sheet 4 and the light-guide sheet 5 was observed in any of Example 1 to Example 10. On the other hand, the contact between the switch holding sheet 4 and the light-guide sheet 5 was observed in the comparative example. One may consider that in the comparative example, the contact occurred because no protrusions 6 were provided.

Next, the switch feeling was tested. Concerning the switch feeling, the quality of the feeling was tested by pressing each switch by use of a flat plate having a diameter of 5 mm. In Table 1, the examples and the comparative example were marked with “∘” when the witch feeling was satisfactory, or with “x” when the witch feeling was poor. As shown in this table, the switch feeling was satisfactory in Example 1 to Example 10. On the other hand, the switch feeling was poor in the comparative example. One may consider that in the comparative example, the switch feeling was poor because no protrusion 6 was provided.

Next, the quality of the switch durability was tested. As shown in Table 1, the switch durability was favorable in any of Example 1 to Example 10.

The above-mentioned results of the experiments proves that the contact between the switch holding sheet 4 and the light-guide sheet 5 can be securely prevented, and the satisfactory switch durability and switch feeling can be obtained, as long as the height of the protrusions is in the range of 0.05 mm to 0.2 mm and the diameter thereof is in the range of 0.7 mm to 2.5 mm.

1. A switch device comprising:
a circuit board provided with a fixed contact;
a deformable contact arranged above the circuit board, and configured to deform and come into contact with the fixed contact in response to pressure from above;
a switch holding sheet covering a surface of the circuit board provided with the deformable contact, and configured to retain the deformable contact on the circuit board;
a light-guide sheet placed over the switch holding sheet, and allowing light to pass through its inside;
a light source configured to cause the light to fall incident and enter the inside of the light-guide sheet; and
a protrusion provided between the switch holding sheet and the light-guide sheet or between the deformable contact and the light-guide sheet in a position corresponding to the deformable contact, and forming a gap between the switch holding sheet and the light-guide sheet.

2. The switch device according to claim 1,
wherein the deformable contact is formed in a dome shape, and
the protrusion is provided in a position corresponding to a top portion of the dome shape of the deformable contact.

3. The switch device according to claim 1,
wherein a height of the protrusion is in a range of 0.05 mm to 0.2 mm, and
a diameter of the protrusion is in a range of 0.7 mm to 2.5 mm.

4. The switch device according to claim 2,
wherein a height of the protrusion is in a range of 0.05 mm to 0.2 mm, and
a diameter of the protrusion is in a range of 0.7 mm to 2.5 mm.

5. The switch device according to claim 1,
wherein the protrusion has any of a columnar shape and a semispherical shape.

6. The switch device according to claim 2,
wherein the protrusion has any of a columnar shape and a semispherical shape.

7. The switch device according to claim 3,
wherein the protrusion has any of a columnar shape and a semispherical shape.

8. The switch device according to claim 4,
wherein the protrusion has any of a columnar shape and a semispherical shape.

9. An electronic apparatus comprising the switch device according to claim 1.

10. An electronic apparatus comprising the switch device according to claim 2.

11. An electronic apparatus comprising the switch device according to claim 3.

12. An electronic apparatus comprising the switch device according to claim 4.

13. An electronic apparatus comprising the switch device according to claim 5.

14. An electronic apparatus comprising the switch device according to claim 6.

15. An electronic apparatus comprising the switch device according to claim 7.

16. An electronic apparatus comprising the switch device according to claim 8.
